(19) United States
(12) Patent Application Publication
(10) Pub. No.: US 2025/0222572 A1
(43) Pub. Date: Jul. 10, 2025

(54) TORQUE CONTROL METHOD AND TORQUE CONTROL DEVICE

(71) Applicant: JIANGSU DONGCHENG TOOLS TECHNOLOGY CO., LTD, Nantong (CN)

(72) Inventors: Xiaotao MU; Yuhua GONG, Nantong (CN)

(21) Appl. No.: 18/852,786

(22) PCT Filed: Sep. 28, 2023
(86) PCT No.: PCT/CN2023/122762

§ 371 Date: Sep. 30, 2024

(30) Foreign Application Priority Data
Aug. 10, 2022 (CN) 202210955324.5

(51) Int. Cl. B25B 23/147; G01L 5/00

(52) U.S. Cl. CPC B25B 23/147; G01L 5/0042

(57) ABSTRACT

The application provides a torque control method and device. The application verifies an effectiveness of a torque according to the first torque value Tset of set by user, the second torque value Ti obtained by gathering parameters, and the third torque value Ts uploaded by one or more torque sensors, and controls operating states of a motor according to the effectiveness of the torque. The application determines whether the torque value is normal and effective by comparing torque values obtained in various ways, greatly improves the accuracy of the torque and improves the control effect of the motor. The application has the advantages of simple processing process, low requirement on the processing capacity of the device, and can realize torque verification without increasing the processing capacity of the equipment, thus reducing the cost and improving the user experience.

### FIELD

The subject matter herein generally relates to a torque control method, a torque control device and computer-readable medium.

### BACKGROUND

In prior art, some power tools have advantages of fast and lightweight, strong practicality and wide range of applications, non-professional users can also operate the power tools. Among existing power tools, for example, electric screwdrivers, electric wrenches, when the non-professional users operate the electric screwdrivers or the electric wrenches, and cannot accurately control torque of a screw, the screw or a bolt may be broken, or the screw or the bolt cannot be tightened. Working of the non-professional users is fail or not perfect. When a workload of the user is large, work efficiency is low.

In order to overcome above problems, some constant torque control methods are usually used, accurate torque values are obtained to meet constant torque control. A China invention patent issued NO. CN114460464A provides some torque acquisition methods, (1) the torque values are calculated according to some obtained motor parameters; (2) the torque values are detected by some torque sensors. However, the motor parameters in the method (1), for example, current and other motor parameters are affected by the environment, equipment aging, equipment wear, and so on. The torque values obtained according to the above current may be different from the actual torque values. A problem in the method (2) is same as the problem in the method (1), due to influence of the torque sensor's own accuracy, equipment aging, environment and other aspects, the torque values detected by the torque sensors may be different from the actual torque values. Accuracy of the torque values obtained through the methods needs to be verified.

On the other hand, due to limitations of the power tools' own processing capacity, some complex methods are easy to exceed the power tools' own processing capacity and cause ‘downtime’ phenomenon. An improved torque control method needs to be provided to achieve accuracy verification of the torque values based on prior processing capabilities.

### SUMMARY

To shortcomings of the prior art, the application provides a torque control method and device with optimized structure and simple scheme to improve accuracy of torque.

The application can adopt the following technical schemes to solve the prior art problems:

The application provides a torque control method comprising: receiving a first torque value Tset of a torque of a motor of presetting; obtaining a second torque value Ti of the torque of the motor according to gathering parameters, wherein the gathering parameters are operating parameters of the motor; obtaining a third torque value Ts of the torque of the motor uploaded by one or more torque sensors; verifying an effectiveness of the torque according to the first torque value Tset, the second torque value Ti, and the third torque value Ts; and controlling operating states of the motor according to the effectiveness of the torque.

Exemplarily, verifying the effectiveness of the torque according to the first torque value Tset, the second torque value Ti, and the third torque value Ts comprises: calculating a first difference value T1 between the first torque value Tset and the second torque value Ti; calculating a second difference value T2 between the second torque value Ti and the third torque value Ts; calculating a third difference value T3 between the first torque value Tset and the third torque value Ts; and verifying the effectiveness of the torque according to the first difference value T1, the second difference value T2, and the third difference value T3; wherein verifying the effectiveness of the torque according to the first difference value T1, the second difference value T2, and the third difference value T3 comprises: outputting an effective result of the torque, when at least one of the first difference value T1, the second difference value T2, and the third difference value T3 meets a validity condition.

Exemplarily, verifying the effectiveness of the torque according to the first torque value Tset, the second torque value Ti, and the third torque value Ts comprises: obtaining corresponding relationships among the second torque value Ti, the third torque value Ts, and torque difference value T; determining the effectiveness of the torque according to the first torque value Tset, the second torque value Ti, the third torque value Ts, and the corresponding relationships.

Exemplarily, determining the effectiveness of the torque according to the first torque value Tset, the second torque value Ti, the third torque value Ts, and the corresponding relationships comprises: calculating a first difference value T1 between the first torque value Tset and the second torque value Ti; calculating a third difference value T3 between the first torque value Tset and the third torque value Ts; calculating a second difference value T2 between the second torque value Ti and the third torque value Ts, when at least one of the first difference value T1, and the third difference value T3 meets a validity condition; obtaining the torque difference value T according to the second torque value Ti and/or the third torque value Ts, and the corresponding relationships; and outputting an effective result of the torque, when a different value between the second difference value T2 and the torque difference value T is less than a specified threshold.

Exemplarily, determining the effectiveness of the torque according to the first torque value Tset, the second torque value Ti, the third torque value Ts, and the corresponding relationships comprises: calculating a first difference value T1 between the first torque value Tset and the second torque value Ti; calculating a second difference value T2 between the second torque value Ti and the third torque value Ts; calculating a third difference value T3 between the first torque value Tset and the third torque value Ts; obtaining the torque difference value T according to the corresponding relationships; outputting an effective result of the torque, when a difference value between the torque difference value T and at least one of the first difference value T1, the second difference value T2, and the third difference value T3 is less than a specified threshold.

The application provides a torque control method comprising obtaining a second torque value Ti of a torque of a motor according to gathering parameters, wherein the gathering parameters are operating parameters of the motor; obtaining a third torque value Ts of the torque of the motor uploaded by one or more torque sensors; verifying an effectiveness of the torque according to the second torque value Ti and the third torque value Ts; and controlling operating states of the motor according to the effectiveness of the torque.

Exemplarily, verifying the effectiveness of the torque according to the second torque value Ti and the third torque value Ts comprises: obtaining corresponding relationships among the second torque value Ti, the third torque value Ts, and torque difference value T; determining the effectiveness of the torque according to the second torque value Ti, the third torque value Ts, and the corresponding relationships.

Exemplarily, determining the effectiveness of the torque according to the second torque value Ti, the third torque value Ts, and the corresponding relationships comprises: calculating a second difference value T2 between the second torque value Ti, the third torque value Ts and the corresponding relationships, or calculating the second difference value T2 between the second torque value Ti and the corresponding relationships, or calculating the second difference value T2 between the third torque value Ts and the corresponding relationships; and outputting an effective result of the torque, when a different value between the second difference value T2 and the torque difference value T is less than a specified threshold.

The application provides a torque control device comprising a first acquisition module receiving a first torque value Tset of a torque of a motor of presetting; a second acquisition module obtaining a second torque value Ti of the torque of the motor according to gathering parameters, wherein the gathering parameters are operating parameters of the motor; a third acquisition module obtaining a third torque value Ts of the torque of the motor uploaded by one or more torque sensors; a verification module verifying an effectiveness of the torque according to the first torque value Tset, the second torque value Ti, and the third torque value Ts; and a control module controlling operating states of the motor according to the effectiveness of the torque.

Exemplarily, the verification module verifying the effectiveness of the torque according to the first torque value Tset, the second torque value Ti, and the third torque value Ts comprises: calculating a first difference value T1 between the first torque value Tset and the second torque value Ti; calculating a second difference value T2 between the second torque value Ti and the third torque value Ts; calculating a third difference value T3 between the first torque value Tset and the third torque value Ts; and verifying the effectiveness of the torque according to the first difference value T1, the second difference value T2, and the third difference value T3; wherein verifying the effectiveness of the torque according to the first difference value T1, the second difference value T2, and the third difference value T3 comprises: outputting an effective result of the torque, when at least one of the first difference value T1, the second difference value T2, and the third difference value T3 meets a validity condition.

Exemplarily, the verification module verifying the effectiveness of the torque according to the first torque value Tset, the second torque value Ti, and the third torque value Ts comprises: obtaining corresponding relationships among the second torque value Ti, the third torque value Ts, and torque difference value T; determining the effectiveness of the torque according to the first torque value Tset, the second torque value Ti, the third torque value Ts, and the corresponding relationships.

Exemplarily, the verification module determining the effectiveness of the torque according to the first torque value Tset, the second torque value Ti, the third torque value Ts, and the corresponding relationships comprises: calculating a first difference value T1 between the first torque value Tset and the second torque value Ti; calculating a third difference value T3 between the first torque value Tset and the third torque value Ts; calculating a second difference value T2 between the second torque value Ti and the third torque value Ts, when at least one of the first difference value T1, and the third difference value T3 meets a validity condition; obtaining the torque difference value T according to the second torque value Ti and/or the third torque value Ts, and the corresponding relationships; and outputting an effective result of the torque, when a different value between the second difference value T2 and the torque difference value T is less than a specified threshold.

Exemplarily, the verification module determining the effectiveness of the torque according to the first torque value Tset, the second torque value Ti, the third torque value Ts, and the corresponding relationships comprises calculating a first difference value T1 between the first torque value Tset and the second torque value Ti; calculating a second difference value T2 between the second torque value Ti and the third torque value Ts; calculating a third difference value T3 between the first torque value Tset and the third torque value Ts; obtaining the torque difference value T according to the corresponding relationships; outputting an effective result of the torque, when a difference value between the torque difference value T and at least one of the first difference value T1, the second difference value T2, and the third difference value T3 is less than a specified threshold.

The application provides a torque control device comprising: a second acquisition module obtaining a second torque value Ti of a torque of a motor according to gathering parameters, wherein the gathering parameters are operating parameters of the motor; a third acquisition module obtaining a third torque value Ts of the torque of the motor uploaded by one or more torque sensors; a verification module verifying an effectiveness of the torque according to the second torque value Ti and the third torque value Ts; and a control module controlling operating states of the motor according to the effectiveness of the torque.

Exemplarily, the verification module verifying the effectiveness of the torque according to the second torque value Ti and the third torque value Ts comprises: obtaining corresponding relationships among the second torque value Ti, the third torque value Ts, and torque difference value T; determining the effectiveness of the torque according to the second torque value Ti, the third torque value Ts, and the corresponding relationships.

Exemplarily, the verification module determining the effectiveness of the torque according to the second torque value Ti, the third torque value Ts, and the corresponding relationships comprises: calculating a second difference value T2 between the second torque value Ti, the third torque value Ts and the corresponding relationships, or calculating the second difference value T2 between the second torque value Ti and the corresponding relationships, or calculating the second difference value T2 between the third torque value Ts and the corresponding relationships; and outputting an effective result of the torque, when a different value between the second difference value T2 and the torque difference value T is less than a specified threshold.

The application provides a torque control device comprising: a human-computer interaction module, a sampling circuit, a processing circuit, torque sensors and a control unit, wherein the human-computer interaction module receives a first torque value Tset of a torque of a motor of presetting, the sampling circuit gathers parameters, the processing circuit obtains a second torque value Ti of the torque of the motor according to the gathering parameters, the gathering parameters are operating parameters of the motor, the torque sensors obtains a third torque value Ts of the torque of the motor, the control unit obtains the first torque value Tset, the second torque value Ti, and the third torque value Ts of the torque of the motor, the control unit verifies an effectiveness of the torque according to the first torque value Tset, the second torque value Ti, and the third torque value Ts, and outputs control information of the motor according to the effectiveness of the torque.

The application provides a torque control device comprising: a sampling circuit, a processing circuit, torque sensors and a control unit, wherein the sampling circuit gathers parameters, the processing circuit obtains a second torque value Ti of the torque of the motor according to the gathering parameters, the gathering parameters are operating parameters of the motor, the torque sensors obtains a third torque value Ts of the torque of the motor, the control unit obtains the second torque value Ti and the third torque value Ts of the torque of the motor, the control unit verifies an effectiveness of the torque according to the second torque value Ti and the third torque value Ts, and outputs control information of the motor according to the effectiveness of the torque.

The application provides a torque control device comprising: one or more processors; and a storage medium, configured to store one or more programs, wherein when the one or more programs run on the one or more processors, to cause the one or more processors to execute a torque control method in accordance with any one of claims 1 to 8.

The application provides a computer storage medium, wherein the computer storage medium stores computer programs, when the computer programs run on a processor, the processor is caused to execute a torque control method in accordance with any one of claims 1 to 8.

Compared with the prior art, the application has the following beneficial effects:

The application provides a torque control method and a torque control device, the application uses the first torque value Tset of the torque of the motor of set by the user, the second torque value Ti of the torque of the motor obtained according to gathering parameters, and the third torque value Ts of the torque of the motor uploaded by the one or more torque sensors to verify the effectiveness of the torque, and controls the motor according to the effectiveness of the torque. The application determines whether the torque value is normal and effective by comparing the torque value obtained in various ways, greatly improves the accuracy of the torque and improves the control effect of the motor. The scheme provided by the application has the advantages of simple processing process, low requirement on the processing capacity of the device, and can realize torque verification without increasing the processing capacity of the equipment, thus reducing the cost and improving the user experience.

### BRIEF DESCRIPTION OF THE DRAWINGS

Implementations of the present disclosure will now be described, by way of embodiments, with reference to the attached figures.

FIG. 1 is a flowchart illustrating a first embodiment of a torque control method according to the present disclosure.

FIG. 2 is a structure diagram illustrating a second embodiment of a torque control method according to the present disclosure

FIG. 3 is a structure diagram illustrating a third embodiment of a torque control device according to the present disclosure.

FIG. 4 is a structure diagram illustrating a fourth embodiment of the torque control device according to the present disclosure.

FIG. 5 is a structure diagram illustrating a fifth embodiment of the torque control device according to the present disclosure.

FIG. 6 is a structure diagram illustrating a sixth embodiment of the torque control device according to the present disclosure.

### DETAILED DESCRIPTION

Implementations of the present disclosure will now be described, by way of embodiments, with reference to the attached figures.

The terms in the present disclosure are only for purpose of describing specific embodiments and are not intended to limit the present disclosure. For example, the following terms, such as “first”, “second”, “third”, etc., are only for the purpose of distinguishing the relevant parameters involved in the present disclosure. The terms are not to be construed as limitations to the present disclosure.

In prior art, for example, the electric screwdrivers, the electric wrenches, when the non-professional users operate the electric screwdrivers or the electric wrenches, and cannot accurately control the torque values of the screw, the screw or the bolt may be broken, or the screw or the bolt cannot be tightened. Working of the non-professional users is fail or not perfect. It is necessary to control constant torque of the motor. In prior art, the torque is controlled by the constant parameters or real-time detection by the torque sensors to complete the constant torque control, deviation of the actual torque values is existed due to the influence of the environment, the equipment aging, the equipment wear and so on, the torque values are failure. In order to realize precise control of the output torque of the motor, the present disclosure provides a method with the simple and accurate constant torque control. The method can accurately control the output torque of the motor, prevent the broken of the screw and the bolt, and accuracy and stability of the fixed torque tool are increased.

### A First Embodiment

In view of the shortcomings of the prior art, the present disclosure provides the optimized and simple torque control method to improve the accuracy of the torque values.

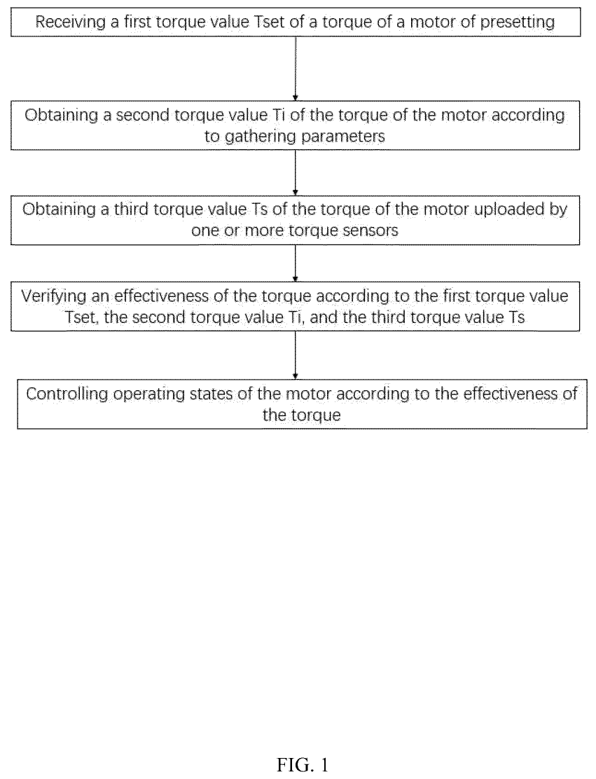

Please refer to FIG. 1, a first torque value Tset of a torque of the motor preset by a user is received. The user sets the one or more torque values through a human-computer interaction module to realize the constant torque control, and the user can control the motor according to the first torque value Tset.

A second torque value Ti of the torque of the motor is obtained according to gathering parameters. During normal operation of the motor, the torque values have a functional relationship with the parameters of the motor. For example, the parameters of the motor can be at least one of the current, a voltage of the motor and so on. The torque values can be determined by the above parameters. Methods of determining the torque values may include: (1) the functional relationship can be obtained through the data training manner, and the torque values are determined according to the functional relationship; (2) a corresponding relation table between the parameters and the torque values is established, and the torque values are determined by querying the corresponding relation table. The functional relationship between the parameters of the motor and the corresponding relation table between the parameters and the torque values are common manners in a field of the electric tools, which will not be repeated here.

A third torque value Ts of the torque of the motor uploaded by one or more torque sensors is obtained.

An effectiveness of the torque is verified according to the first torque value Tset, the second torque value Ti, and the third torque value Ts.

Operating states of the motor is controlled according to the effectiveness of the torque. The effective torque values are determined through the effectiveness of the torque, the motor can be controlled based on the effective torque values, precision of motor control is improved by improving the accuracy of the torque values.

The method of the present disclosure obtains the multiple torque values by different manners, the effectiveness of the torque can be obtained by comparing multiple torque values, problems of inaccurate torque values caused by the environment, the equipment aging, or other factors can be avoided, the accuracy of the torque values is improved. The accuracy of the torque values also increases precision and stability of the power tools.

A method of verifying the effectiveness of the torque according to the first torque value Tset, the second torque value Ti, and the third torque value Ts includes: calculating a first difference value T1 between the first torque value Tset and the second torque value Ti, calculating a second difference value T2 between the second torque value Ti and the third torque value Ts, calculating a third difference value T3 between the first torque value Tset and the third torque value Ts, and verifying the effectiveness of the torque according to the first difference value T1, the second difference value T2, and the third difference value T3.

A method of verifying the effectiveness of the torque according to the first difference value T1, the second difference value T2, and the third difference value T3 includes: when at least one of the first difference value T1, the second difference value T2, and the third difference value T3 meets a validity condition, outputting an effective result of the torque, controlling the operating states of the motor according to the effective result of the torque. In one embodiment, the validity condition can be a value, or a range. For example, the values of the first difference value T1, the second difference value T2, and the third difference value T3 are 0. Due to the influence of the environment, the equipment aging and other factors, the second torque value Ti determined by the parameters and the third torque value Ts detected by the torque sensors have the deviation, the second torque value Ti determined by the parameters and/or has the deviation, the third torque value Ts detected by the torque sensors has the deviation, and the first validity condition is a deviation value. When absolute values of the first difference value T1, the second difference value T2, and the third difference value T3 are less than the deviation value, the first torque value Tset, the second torque value Ti, and the third torque value Ts are effective.

In some embodiments, the validity condition can bean allowable range, if the first difference value T1, the second difference value T2, and the third difference value T3 are within the allowable range, the first torque value Tset, the second torque value Ti, and the third torque value Ts are effective. In one embodiment, the deviation value and the allowable range can be set differently by technicists according to working conditions of each tool and the different environment, which is common manner in a field of the power tools and will not be repeated here. A verification method of the effectiveness of the torque has a simple processing manner for the torque values, and requirements for the processing capacity of equipment control units is low, the equipment control units do not be upgraded. The verification method of the effectiveness of the torque can be completed by prior control units, and cost of perfecting function of the equipment can be reduced.

In one embodiment, the torque control method also includes determining one or more abnormal torque values according to the first difference value T1, the second difference value T2, and the third difference value T3. The effectiveness of the torque can be determined through the above method, when the one or more difference values does not meet the validity condition, the abnormal torque value can be determined based on the one or more difference values. For example, when the first difference value T1 meets the validity condition, the second difference value T2 does not meet the validity condition, the torque values detected by the torque sensors may be abnormal, the power tool sends an abnormal alarm, the user can perform abnormal detection according to the abnormal alarm, such as the torque sensors are determined to be calibrated or not. In one embodiment, the abnormal alarm can be one or more kinds of sound, vibration, indicator light, data display and so on. The human-computer interaction module can display the one or more abnormal torque values and sources of the torque values (such as the torque sensors) to improve user's experience.

In one embodiment, the method of verifying the effectiveness of the torque according to the first torque value Tset, the second torque value Ti, and the third torque value Ts includes: obtaining corresponding relationships among the second torque value Ti, the third torque value Ts, and torque difference value T, determining the effectiveness of the torque according to the first torque value Tset, the second torque value Ti, the third torque value Ts, and the corresponding relationships. A method of determining the effectiveness of the torque according to the first torque value Tset, the second torque value Ti, the third torque value Ts, and the corresponding relationships includes some substeps.

The first difference value T1 is calculated between the first torque value Tset and the second torque value Ti.

The third difference value T3 is calculated between the first torque value Tset and the third torque value Ts.

When at least one of the first difference value T1, and the third difference value T3 meets the validity condition, the validity condition is the same as the above validity condition, which will not be repeated here.

The second difference value T2 is calculated between the second torque value Ti and the third torque value Ts.

The torque difference value T is obtained according to the second torque value Ti, the third torque value Ts, and the corresponding relationships, or the torque difference value T is obtained according to the second torque value Ti and the corresponding relationships, or the torque difference value T is obtained according to the third torque value Ts, and the corresponding relationships. The torque difference value T is queried from the corresponding relationships, according to the second torque value Ti or the third torque value Ts. In some embodiments, when a torque difference value queried according to the second torque value Ti is different from a torque difference value queried according to the third torque value Ts, a first torque difference value queried according to the second torque value Ti and a second torque difference value queried according to the third torque value Ts are compared with T2 respectively.

When a difference value between T2 and T is less than a specified threshold, the effective result of the torque is output. When a difference value between the first torque difference value and T2 is less than the specified threshold, and a difference value between the second torque difference value and T2 is less than the specified threshold, the effectiveness of the torque is output, otherwise abnormal torque message is output. Effective threshold and abnormal threshold can be determined through the above method, and the user can set display mode of the torque according to actual needs, such as displaying the effective torque values and the abnormal torque values, or the effective torque values, or the abnormal torque values. Control operations of the motor can be performed according to the effective torque values, maintenance operations of the motor can be performed according to the abnormal torque values.

Another optional verification method of the effectiveness of the torque is provided, in a verification process, the above verification method of the effectiveness of the torque divides a calculation process of the verification method into multiple substeps and progressively performs multiple substeps, which further reduces requirement of the processing capacity of the equipment control units, and the accuracy of the torque is improved.

In one embodiment, the method of determining the effectiveness of the torque according to the first torque value Tset, the second torque value Ti, the third torque value Ts, and the corresponding relationships includes: calculating a first difference value T1 between the first torque value Tset and the second torque value Ti, calculating a second difference value T2 between the second torque value Ti and the third torque value Ts, calculating a third difference value T3 between the first torque value Tset and the third torque value Ts, obtaining the torque difference value T according to the corresponding relationships, querying the torque difference value T from the correspondence relationship according to the second torque value Ti or the third torque value Ts.

In one embodiment, when the torque difference value queried according to the second torque value Ti is different from the torque difference value queried according to the third torque value Ts, the first torque difference value queried according to the second torque value Ti and the second torque difference value queried according to the third torque value Ts are compared with T1, T2 and T3 respectively.

When a different value between at least one of the first difference value T1, the second difference value T2, the third difference value T3 and the torque difference value T is less than the specified threshold, the effective result of the torque is output. When the first torque difference value and the second torque difference value are compared with T1, T2, and T3 respectively, when the above specified threshold condition is met, the effective result of the torque is output, otherwise, the abnormal torque message is output. The effective threshold and the abnormal threshold can be determined through the above method, because multiple torque difference values are compared with multiple difference values at the same time, the second torque value Ti and the third torque value Ts both indicate abnormal conditions, the user is reminded to detect the power tools through abnormal alarm mode, the using safety of the power tools is improved. The user can set display mode of the torque according to actual needs, such as displaying the effective torque values and/or the abnormal torque values, or displaying the effective torque values, or displaying the abnormal torque values. Control operations of the motor can be performed according to the effective torque values, maintenance operations of the motor can be performed according to the abnormal torque values.

Another optional verification method of the effectiveness of the torque is provided, the effectiveness of the torque is determined based on the corresponding relationships among the second torque value Ti, the third torque value Ts, and torque difference value T. Since the corresponding relationships is stored in a device in advance, in actual operation process, the corresponding relationships does not need to be set by the user, professional requirements of the users are reduced, new users can effectively complete the above operations, the user's experience is improved.

The effectiveness of the torque can be determined through the above method, when the one or more difference values does not meet the specified threshold condition, the abnormal torque value can be determined based on the one or more difference values. For example, when the first difference value T1 meets the threshold condition, the second difference value T2 does not meet the threshold condition, the torque values detected by the torque sensors may be abnormal, the power tool sends an abnormal alarm, the user can perform abnormal detection according to the abnormal alarm, such as the torque sensors are determined to be calibrated or not. In one embodiment, the abnormal alarm can be one or more kinds of sound, vibration, indicator light, data display and so on. The human-computer interaction module can display the one or more abnormal torque values and sources of the torque values (such as the torque sensors) to improve user's experience.

In one embodiment, the torque control method also includes a training method. The training method includes: obtaining the second torque value Ti according to the gathering parameters, obtaining the third torque value Ts uploaded by one or more torque sensors, calculating the torque difference value T between the second torque value Ti and the third torque value Ts, saving the corresponding relationships among the second torque value Ti, the third torque value Ts, and the torque difference value T.

The equipment appears aging and other conditions with increasing use time of the equipment, such as the power tools, the corresponding relationships among the second torque value Ti, the third torque value Ts, and the torque difference value T maintained in the equipment changes, or when the equipment is applied in a new scene, the corresponding relationships among the second torque value Ti, the third torque value Ts, and the torque difference value T does not be covered, and the training method is set. When the equipment is operated, the user performs some ways to make the equipment enter the training module, such as a model switch, and the training method is performed. In some embodiments, according to the needs of the user, the power tools enters corresponding working state, the second torque value Ti, the third torque value Ts and the torque difference valueT under different working states can be collected respectively, the corresponding relationships among the second torque value Ti, the third torque value Ts, and the torque difference value T is established and saved. The corresponding relationships among the second torque value Ti, the third torque value Ts, and the torque difference value T can be saved a separate memory or in a storage module inside the control unit. The training method can meet the requirements of different users and different scenarios to improve the user's experience.

### A Second Embodiment

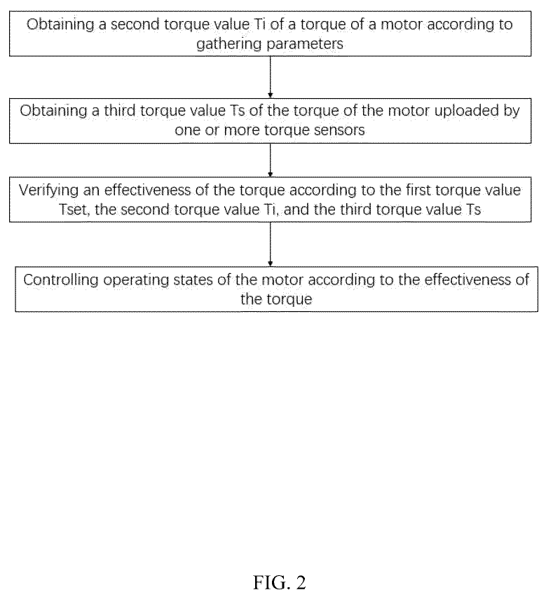

Please refer to FIG. 2, in order to overcome the problems existing in the prior art and improve the accuracy of torque control, a torque control method is provided. The torque control method includes some substeps.

The second torque value Ti is obtained according to gathering parameters. During the normal operation of the motor, the torque values have the functional relationship with the parameters of the motor. For example, the parameters of the motor can be at least one of the current, the voltage of the motor and so on. The torque values can be determined by the above parameters. The methods of determining the torque values may include: (1) the functional relationship can be obtained through the data training manner, and the torque values are determined according to the functional relationship; (2) the corresponding relation table between the parameters and the torque values is established, and the torque values are determined by querying the corresponding relation table. The functional relationship between the parameters of the motor and the corresponding relation table between the parameters and the torque values are common manners in the field of the power tools, which will not be repeated here.

The third torque value Ts uploaded by one or more torque sensors is obtained. An effectiveness of a torque according to the second torque value Ti, and the third torque value Ts is verified. The effective torque values are determined through the effectiveness of the torque, the motor can be controlled based on the effective torque values, precision of motor control is improved by improving the accuracy of the torque values.

The method of the present disclosure obtains the multiple torque values by different manners, the effectiveness of the torque can be obtained by comparing multiple torque values, problems of inaccurate torque values caused by the environment, the equipment aging, or other factors can be avoided, the accuracy of the torque values is improved. The accuracy of the torque values also increases precision and stability of the power tools.

In one embodiment, a method of verifying the effectiveness of the torque according to the second torque value Ti, and the third torque value Ts includes: obtaining corresponding relationships among the second torque value Ti, the third torque value Ts, and torque difference value T, determining the effectiveness of the torque according to the second torque value Ti, the third torque value Ts, and the corresponding relationships. A method of determining the effectiveness of the torque according to the second torque value Ti, the third torque value Ts, and the corresponding relationships includes some substeps.

The difference value T2 between the second torque value Ti and the third torque value Ts is calculated.

The torque difference value T is obtained according to the second torque value Ti, the third torque value Ts, and the corresponding relationships, or the torque difference value T is obtained according to the second torque value Ti and the corresponding relationships, or the torque difference value T is obtained according to the third torque value Ts, and the corresponding relationships. The torque difference value T is queried from the corresponding relationships, according to the second torque value Ti or the third torque value Ts. In one embodiment, when a torque difference value queried according to the second torque value Ti is different from a torque difference value queried according to the third torque value Ts, a first torque difference value queried according to the second torque value Ti and a second torque difference value queried according to the third torque value Ts are compared with T2 respectively.

The effective result of the torque is output, when the difference value between T2 and T is less than the specified threshold, otherwise abnormal torque message is output. Effective threshold and abnormal threshold can be determined through the above method, and the user can set display mode of the torque according to actual needs, such as displaying the effective torque values and the abnormal torque values, or displaying the effective torque values, or displaying the abnormal torque values. Control operations of the motor can be performed according to the effective torque values, maintenance operations of the motor can be performed according to the abnormal torque values.

The verification method of the effectiveness of the torque is provided in the second embodiment, the effectiveness of the torque is determined based on the corresponding relationships among the second torque value Ti, the third torque value Ts, and torque difference value T. Since the corresponding relationships is stored in a device in advance, in actual operation process, the corresponding relationships does not need to be set by the user, professional requirements of the users are reduced, new users can effectively complete the above operations, the user's experience is improved.

The effectiveness of the torque can be determined through the above method, when the one or more difference values does not meet the specified threshold condition, the abnormal torque value can be determined based on the one or more difference values. The power tool sends an abnormal alarm, the user can perform abnormal detection according to the abnormal alarm, such as the torque sensors are determined to be calibrated or not. In one embodiment, the abnormal alarm can be one or more kinds of sound, vibration, indicator light, data display and so on. The human-computer interaction module can display the one or more abnormal torque values and sources of the torque values (such as the torque sensors) to improve the user's experience.

In one embodiment, the torque control method also includes the training method. The training method includes: obtaining the second torque value Ti according to the gathering parameters, obtaining the third torque value Ts uploaded by one or more torque sensors, calculating the torque difference value T between the second torque value Ti and the third torque value Ts, saving the corresponding relationships among the second torque value Ti, the third torque value Ts, and the torque difference value T.

The equipment appears aging and other conditions with increasing the use time of the equipment, such as the power tools, the corresponding relationships among the second torque value Ti, the third torque value Ts, and the torque difference value T maintained in the equipment changes, or when the equipment is applied in the new scene, the corresponding relationships among the second torque value Ti, the third torque value Ts, and the torque difference value T does not be covered, and the training method is set. When the equipment is operated, the user performs some ways to make the equipment enter the training module, such as the model switch, and the training method is performed. In some embodiments, according to the needs of the user, the power tools enters corresponding working state, the second torque value Ti, the third torque value Ts and the torque difference valueT under different working states can be collected respectively, the corresponding relationships among the second torque value Ti, the third torque value Ts, and the torque difference value T is established and saved. The corresponding relationships among the second torque value Ti, the third torque value Ts, and the torque difference value T can be saved a separate memory or in a storage module inside the control unit. The training method can meet the requirements of different users and different scenarios to improve the user's experience.

### A Third Embodiment

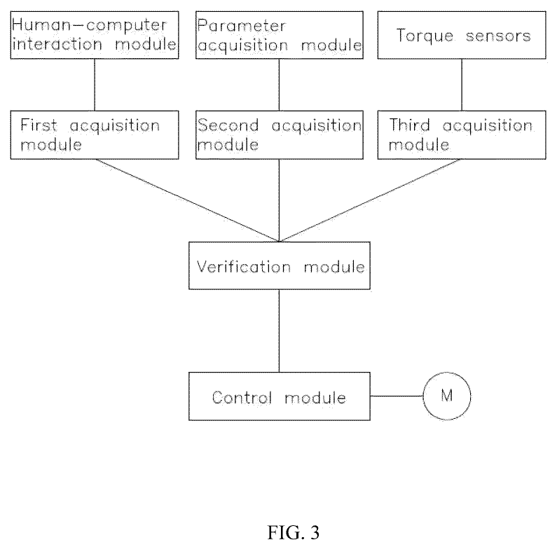

Please refer to FIG. 3, a torque control device is provided. The torque control device can perform the torque control method in the first embodiment. The torque control device includes a first acquisition module, a second acquisition module, a third acquisition module, a verification module and a control module.

The first acquisition module receives the first torque value Tset of presetting set by the user. In order to realize the constant torque control, the user sets the torque value through a human-computer interaction module to control the motor according to the first torque value.

The second acquisition module obtains the second torque value Ti according to gathering parameters. During the normal operation of the motor, the torque values have the functional relationship with the parameters of the motor. For example, the parameters of the motor can be at least one of the current, the voltage of the motor and so on. The torque values can be determined by the above parameters acquired a parameter acquisition module. The methods of determining torque values include: (1) the functional relationship can be obtained through the data training manner, and the torque values are determined according to the functional relationship; (2) the corresponding relation table between the parameters and the torque values is established, and the torque values are determined by querying the corresponding relation table. The functional relationship and the corresponding relation table are the common manners in the field of the power tools, which will not be repeated here.

The third acquisition module obtains the third torque value Ts uploaded by the one or more torque sensors.

The verification module verifies the effectiveness of the torque according to the first torque value Tset, the second torque value Ti, and the third torque value Ts.

The control module controls the operating states of the motor according to the effectiveness of the torque. The effective torque values are determined through the effectiveness of the torque, the motor can be controlled based on the effective torque values, precision of motor control is improved by improving the accuracy of the torque values.

Division of the modules in the torque control device is only an illustrative representation. In some embodiments, the first acquisition module, the second acquisition module and the third acquisition module can also be integrated into an acquisition module to achieve acquisition of relevant torque values. The verification module can be integrated in the control module.

The torque control device of the present disclosure obtains the multiple torque values by different manners, the effectiveness of the torque can be obtained by comparing multiple torque values, the problems of inaccurate torque values caused by the environment, the equipment aging, or other factors can be avoided, the accuracy of the torque values is improved. The accuracy of the torque values also increases precision and stability of the power tools.

In one embodiment, the verification module calculates the first difference value T1 between the first torque value Tset and the second torque value Ti is, calculates the second difference value T2 between the second torque value Ti and the third torque value Ts, calculates the third difference value T3 between the first torque value Tset and the third torque value Ts, and verifies the effectiveness of the torque according to the first difference value T1, the second difference value T2, and the third difference value T3.

The verification module verifying the effectiveness of the torque according to the first difference value T1, the second difference value T2, and the third difference value T3 includes some substeps. The verification module outputs the effective result of the torque, when at least one of the first difference value T1, the second difference value T2, and the third difference value T3 meets a validity condition, operating states of the motor is controlled according to the effective result of the torque. In one embodiment, the validity condition can be a value, or a range. For example, the values of the first difference value T1, the second difference value T2, and the third difference value T3 are 0. Due to the influence of the environment, the equipment aging and other factors, the second torque value Ti determined by the parameters and the third torque value Ts detected by the torque sensors have the deviation, or the second torque value Ti determined by the parameters has the deviation, or the third torque value Ts detected by the torque sensors has the deviation, and the validity condition is a deviation value. When absolute values of the first difference value T1, the second difference value T2, and the third difference value T3 are less than the deviation value, the first torque value Tset, the second torque value Ti, and the third torque value Ts are effective.

In some embodiments, the validity condition can be the allowable range, if the first difference value T1, the second difference value T2, and the third difference value T3 are within the allowable range, the first torque value Tset, the second torque value Ti, and the third torque value Ts are effective. In one embodiment, the deviation value and the allowable range can be set differently by technicists according to working conditions of each tool and the different environment, which is common manners in a field of the power tools and will not be repeated here. The verification method of the effectiveness of the torque has a simple processing manner for the torque values, and requirements for the processing capacity of equipment control units is low, the equipment control units do not be upgraded. The verification method of the effectiveness of the torque can be completed by prior control units, and the cost of perfecting function of the equipment can be reduced.

In one embodiment, the control module also determines the one or more abnormal torque values according to the first difference value T1, the second difference value T2, and the third difference value T3. The effectiveness of the torque can be determined through the above method, when the one or more difference values does not meet the validity condition, the abnormal torque value can be determined based on the one or more difference values. For example, when the first difference value T1 meets the validity condition, the second difference value T2 does not meet the validity condition, the torque values detected by the torque sensors may be abnormal, the power tool sends an abnormal alarm, the user can perform abnormal detection according to the abnormal alarm, such as the torque sensors are determined to be calibrated or not. In one embodiment, the abnormal alarm can be one or more kinds of sound, vibration, indicator light, data display and so on. The human-computer interaction module can display the one or more abnormal torque values and sources of the torque values (such as the torque sensors) to improve the user's experience.

The verification module also obtains the corresponding relationships among the second torque value Ti, the third torque value Ts, and torque difference value T, determines the effectiveness of the torque according to the first torque value Tset, the second torque value Ti, the third torque value Ts, and the corresponding relationships. The verification module determining the effectiveness of the torque according to the first torque value Tset, the second torque value Ti, the third torque value Ts, and the corresponding relationships includes some substeps.

The verification module calculates the first difference value T1 between the first torque value Tset and the second torque value Ti, calculates the third difference value T3 between the first torque value Tset and the third torque value Ts, calculates the second difference value T2 between the second torque value Ti and the third torque value Ts, when at least one of the first difference value T1, and the third difference value T3 meets the validity condition. The verification module obtains the torque difference value T according to the second torque value Ti, the third torque value Ts, and the corresponding relationships, or the verification module obtains the torque difference value T according to the second torque value Ti and the corresponding relationships, or the verification module obtains the torque difference value T according to the third torque value Ts and the corresponding relationships. The verification module outputs the effective result of the torque, when a difference value between T2 and T is less than the specified threshold.

Another optional verification method of the effectiveness of the torque is provided, in a verification process, the above verification method of the effectiveness of the torque divides a calculation process of the verification method into multiple substeps and progressively performs multiple substeps, which further reduces requirement of the processing capacity of the equipment control units, and the accuracy of the torque is improved.

In other embodiments, the verification module determining the effectiveness of the torque according to the first torque value Tset, the second torque value Ti, the third torque value Ts, and the corresponding relationships includes some substeps. The verification module calculates the first difference value T1 between the first torque value Tset and the second torque value Ti, calculates the second difference value T2 between the second torque value Ti and the third torque value Ts, calculates the third difference value T3 between the first torque value Tset and the third torque value Ts, and obtains the torque difference value T according to the corresponding relationships. The verification module outputs the effective result of the torque, when a different value between at least one of the first difference value T1, the second difference value T2, the third difference value T3 and the torque difference value T is less than the specified threshold.

Another optional verification method of the effectiveness of the torque is provided, the effectiveness of the torque is determined based on the corresponding relationships among the second torque value Ti, the third torque value Ts, and torque difference value T. Since the corresponding relationships is stored in a device in advance, in actual operation process, the corresponding relationships does not need to be set by the user, professional requirements of the users are reduced, new users can effectively complete the above operations, the user's experience is improved.

The effectiveness of the torque can be determined through the above method, when the one or more difference values does not meet the specified threshold condition, the abnormal torque value can be determined based on the one or more difference values. For example, when the first difference value T1 meets the threshold condition, the second difference value T2 does not meet the threshold condition, the torque values detected by the torque sensors may be abnormal, the power tool sends an abnormal alarm, the user can perform abnormal detection according to the abnormal alarm, such as the torque sensors are determined to be calibrated or not. In one embodiment, the abnormal alarm can be one or more kinds of sound, vibration, indicator light, data display and so on. The human-computer interaction module can display the one or more abnormal torque values and sources of the torque values (such as the torque sensors) to improve the user's experience.

In one embodiment, the torque control device also includes a training module. The training module obtains the second torque value Ti according to the gathering parameters, obtains the third torque value Ts uploaded by the one or more torque sensors, calculates the torque difference value T between the second torque value Ti and the third torque value Ts, and saves the corresponding relationships among the second torque value Ti, the third torque value Ts, and the torque difference value T.

In one embodiment, the torque control device is the power tools. The power tools can be electric wrench, electric screwdriver, electric drill, and so on.

The equipment appears aging and other conditions with increasing use time of the equipment, such as the power tools, the corresponding relationships among the second torque value Ti, the third torque value Ts, and the torque difference value T maintained in the equipment changes, or when the equipment is applied in a new scene, the corresponding relationships among the second torque value Ti, the third torque value Ts, and the torque difference value T does not be covered, and the training method is set. When the equipment is operated, the user performs some ways to make the equipment enter the training module, such as the model switch, and the training module is performed. In some embodiments, according to the needs of the user, the power tools enters corresponding working state, the second torque value Ti, the third torque value Ts and the torque difference valueT under different working states can be collected respectively, the corresponding relationships among the second torque value Ti, the third torque value Ts, and the torque difference value T is established and saved. The corresponding relationships among the second torque value Ti, the third torque value Ts, and the torque difference value T can be saved the separate memory or in the storage module inside the control unit. The training method can meet the requirements of different users and different scenarios to improve the user's experience.

### A Fourth Embodiment

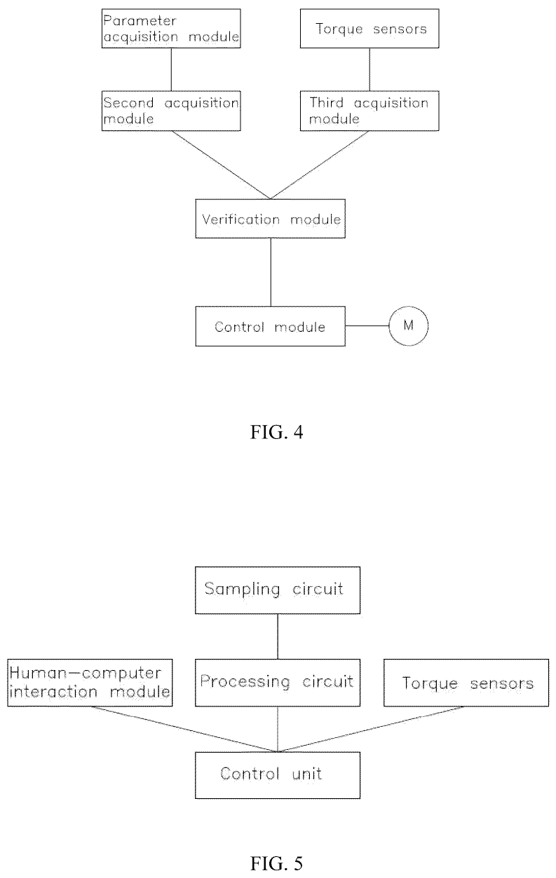

Please refer to FIG. 4, FIG. 4 shows a torque control device. The torque control device can perform the torque control method in the second embodiment. The torque control device includes the second acquisition module, the third acquisition module, and a verification module.

The second acquisition module obtains the second torque value Ti according to gathering parameters. During the normal operation of the motor, the torque values have the functional relationship with the parameters of the motor. For example, the parameters of the motor can be at least one of the current, the voltage of the motor and so on. The torque values can be determined by the above parameters acquired the parameter acquisition module. The methods of determining torque values include: (1) the functional relationship can be obtained through the data training manner, and the torque values are determined according to the functional relationship; (2) the corresponding relation table between the parameters and the torque values is established, and the torque values are determined by querying the corresponding relation table. The functional relationship and the corresponding relation table are the common manners in the field of the power tools, which will not be repeated here.

The third acquisition module obtains the third torque value Ts uploaded by the one or more torque sensors.

The verification module verifies the effectiveness of the torque according to the second torque value Ti and the third torque value Ts. The effective torque values are determined through the effectiveness of the torque, the motor can be controlled based on the effective torque values, the precision of motor control is improved by improving the accuracy of the torque values.

Division of the modules in the torque control device is only an illustrative representation. In some embodiments, the second acquisition module and the third acquisition module can also be integrated into an acquisition module to achieve acquisition of relevant torque values. The torque control device also includes a control module, the verification module can be integrated in the control module, the motor can be controlled based on the effectiveness of the torque.

The torque control device of the present disclosure obtains the multiple torque values by different manners, the effectiveness of the torque can be obtained by comparing multiple torque values, the problems of the inaccurate torque values caused by the environment, the equipment aging, or other factors can be avoided, the accuracy of the torque values is improved. The accuracy of the torque values also increases precision and stability of the power tools.

In some embodiments, the verification module also obtains the corresponding relationships among the second torque value Ti, the third torque value Ts, and torque difference value T, determines the effectiveness of the torque according to the second torque value Ti, the third torque value Ts, and the corresponding relationships. The the verification module determining the effectiveness of the torque according to the second torque value Ti, the third torque value Ts, and the corresponding relationships includes some substeps. The verification module obtains the second difference value T2 between the second torque value Ti and the third torque value Ts, and obtains the torque difference value T according to the second torque value Ti, the third torque value Ts, and the corresponding relationships, or the verification module obtains the torque difference value T according to the second torque value Ti and the corresponding relationships, or the verification module obtains the torque difference value T according to the third torque value Ts and the corresponding relationships. The verification module queries the torque difference value T from the corresponding relationships, according to the second torque value Ti or the third torque value Ts. In other embodiments, when the torque difference value queried according to the second torque value Ti is different from the torque difference value queried according to the third torque value Ts, the first torque difference value queried according to the second torque value Ti and the second torque difference value queried according to the third torque value Ts are compared with T2 respectively.

The effective result of the torque is output, when the difference value between T2 and T is less than the specified threshold.

The verification method of the effectiveness of the torque is provided in the fourth embodiment, the effectiveness of the torque is determined based on the corresponding relationships among the second torque value Ti, the third torque value Ts, and torque difference value T. Since the corresponding relationships is stored in a device in advance, in actual operation process, the corresponding relationships does not need to be set by the user, professional requirements of the users are reduced, new users can effectively complete the above operations, the user's experience is improved.

In one embodiment, the torque control device also includes the training module. The training module includes: obtaining the second torque value Ti according to the gathering parameters, obtaining the third torque value Ts uploaded by one or more torque sensors, calculating the torque difference value T between the second torque value Ti and the third torque value Ts, saving the corresponding relationships among the second torque value Ti, the third torque value Ts, and the torque difference value T.

The equipment appears aging and other conditions with increasing the use time of the equipment, such as the power tools, the corresponding relationships among the second torque value Ti, the third torque value Ts, and the torque difference value T maintained in the equipment changes, or when the equipment is applied in the new scene, the corresponding relationships among the second torque value Ti, the third torque value Ts, and the torque difference value T does not be covered, and the training method is set. When the equipment is operated, the user performs some ways to make the equipment enter the training module, such as the model switch, and the training module is performed. In some embodiments, according to the needs of the user, the power tools enters corresponding working state, the second torque value Ti, the third torque value Ts and the torque difference valueT under different working states can be collected respectively, the corresponding relationships among the second torque value Ti, the third torque value Ts, and the torque difference value T is established and saved. The corresponding relationships among the second torque value Ti, the third torque value Ts, and the torque difference value T can be saved a separate memory or in a storage module inside the control unit. The training module can meet the requirements of different users and different scenarios to improve the user's experience.

### A Fifth Embodiment

Please refer to FIG. 5, FIG. 5 shows a torque control device. The torque control device can perform the torque control method in the first embodiment. The torque control device includes a human-computer interaction module, a sampling circuit, a processing circuit, the one or more torque sensors, and a control unit.

The human-computer interaction module receives the first torque value Tset set by the user. The user sets the one or more torque values through the human-computer interaction module to realize the constant torque control, and the user can control the motor according to the first torque value Tset.

The sampling circuit gathers some parameters. The processing circuit obtains the second torque value Ti according to the gathering parameters. During the normal operation of the motor, the torque values have the functional relationship with the parameters of the motor. For example, the parameters of the motor can be at least one of the current, the voltage of the motor and so on. The torque values can be determined by the above parameters. The methods of determining torque values include: (1) the functional relationship can be obtained through the data training manner, and the torque values are determined according to the functional relationship; (2) the corresponding relation table between the parameters and the torque values is established, and the torque values are determined by querying the corresponding relation table. The functional relationship and the corresponding relation table are the common manners in the field of the power tools, which will not be repeated here.

The one or more torque sensors obtains the third torque value Ts.

The control unit obtains the first torque value Tset, the second torque value Ti, and the third torque value Ts, the control unit verifies the effectiveness of torque according to the first torque value Tset, the second torque value Ti, and the third torque value Ts, and outputs the control information of the motor according to the effectiveness of the torque. The control unit also performs the verification process of the effectiveness of the torque in the first embodiment, the verification process of the effectiveness of the torque is detailed in the first embodiment. The effective torque values are determined through the effectiveness of the torque, the motor can be controlled based on the effective torque values, precision of motor control is improved by improving the accuracy of the torque values.

The method of the present disclosure obtains the multiple torque values by different manners, the effectiveness of the torque can be obtained by comparing multiple torque values, problems of inaccurate torque values caused by the environment, the equipment aging, or other factors can be avoided, the accuracy of the torque values is improved. The accuracy of the torque values also increases precision and stability of the power tools.

In one embodiment, the control unit also performs the training method. The training method includes: obtaining the second torque value Ti according to the gathering parameters, obtaining the third torque value Ts detected by one or more torque sensors, calculating the torque difference value T between the second torque value Ti and the third torque value Ts, saving the corresponding relationships among the second torque value Ti, the third torque value Ts, and the torque difference value T.

In one embodiment, the torque control device is the power tools. The power tools can be electric wrench, electric screwdriver, electric drill, and so on.

The equipment appears aging and other conditions with increasing the use time of the equipment, such as the power tools, the corresponding relationships among the second torque value Ti, the third torque value Ts, and the torque difference value T maintained in the equipment changes, or when the equipment is applied in the new scene, the corresponding relationships among the second torque value Ti, the third torque value Ts, and the torque difference value T does not be covered, and the training method is set. When the equipment is operated, the user performs some ways to make the equipment enter the training method, such as the model switch, and the training method is performed. In some embodiments, according to the needs of the user, the power tools enters corresponding working state, the second torque value Ti, the third torque value Ts and the torque difference valueT under different working states can be collected respectively, the corresponding relationships among the second torque value Ti, the third torque value Ts, and the torque difference value T is established and saved. The corresponding relationships among the second torque value Ti, the third torque value Ts, and the torque difference value T can be saved a separate memory or in a storage module inside the control unit. The training method can meet the requirements of different users and different scenarios to improve the user's experience.

### A Sixth Embodiment

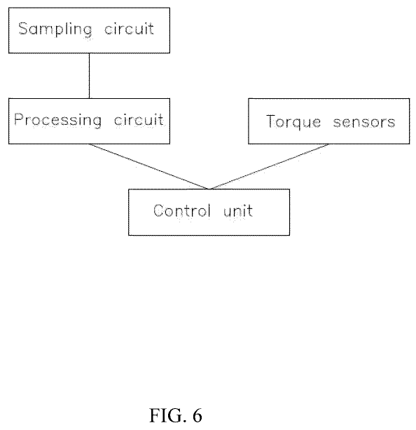

Please refer to FIG. 6, FIG. 6 shows a torque control device. The torque control device can perform the torque control method in the second embodiment. The torque control device includes a sampling circuit, a processing circuit, the one or more torque sensors, and a control unit.

The sampling circuit gathers some parameters. The processing circuit obtains the second torque value Ti according to the gathering parameters. During the normal operation of the motor, the torque values have the functional relationship with the parameters of the motor. For example, the parameters of the motor can be at least one of the current, the voltage of the motor and so on. The torque values can be determined by the above parameters. The methods of determining torque values include: (1) the functional relationship can be obtained through the data training manner, and the torque values are determined according to the functional relationship; (2) the corresponding relation table between the parameters and the torque values is established, and the torque values are determined by querying the corresponding relation table. The functional relationship and the corresponding relation table are the common manners in the field of the power tools, which will not be repeated here.

The one or more torque sensors obtains the third torque value Ts.

The control unit obtains the second torque value Ti, and the third torque value Ts, the control unit verifies the effectiveness of torque according to the second torque value Ti, and the third torque value Ts, and outputs the control information of the motor according to the effectiveness of the torque. The control unit also performs the verification process of the effectiveness of the torque in the second embodiment, the verification process of the effectiveness of the torque is detailed in the second embodiment. The effective torque values are determined through the effectiveness of the torque, the motor can be controlled based on the effective torque values, precision of motor control is improved by improving the accuracy of the torque values.

The method of the present disclosure obtains the multiple torque values by different manners, the effectiveness of the torque can be obtained by comparing multiple torque values, problems of inaccurate torque values caused by the environment, the equipment aging, or other factors can be avoided, the accuracy of the torque values is improved. The accuracy of the torque values also increases precision and stability of the power tools.

In one embodiment, the control unit also performs the training method. The training method includes: obtaining the second torque value Ti according to the gathering parameters, obtaining the third torque value Ts detected by one or more torque sensors, calculating the torque difference value T between the second torque value Ti and the third torque value Ts, saving the corresponding relationships among the second torque value Ti, the third torque value Ts, and the torque difference value T.

In one embodiment, the torque control device is the power tools. The power tools can be electric wrench, electric screwdriver, electric drill, and so on.

The equipment appears aging and other conditions with increasing the use time of the equipment, such as the power tools, the corresponding relationships among the second torque value Ti, the third torque value Ts, and the torque difference value T maintained in the equipment changes, or when the equipment is applied in the new scene, the corresponding relationships among the second torque value Ti, the third torque value Ts, and the torque difference value T does not be covered, and the training method is set. When the equipment is operated, the user performs some ways to make the equipment enter the training method, such as the model switch, and the training method is performed. In some embodiments, according to the needs of the user, the power tools enters corresponding working state, the second torque value Ti, the third torque value Ts and the torque difference value T under different working states can be collected respectively, the corresponding relationships among the second torque value Ti, the third torque value Ts, and the torque difference value T is established and saved. The corresponding relationships among the second torque value Ti, the third torque value Ts, and the torque difference value T can be saved a separate memory or in a storage module inside the control unit. The training method can meet the requirements of different users and different scenarios to improve the user's experience.

In one embodiment, a torque control device is provided. The torque control device includes at least one processor and a data storage. The data storage stores one or more programs which can be executed by the at least one processor. The data storage is used to store instructions, and the processor is used to call up instructions from the data storage, so that the processor performs the steps of the torque control method in the above embodiment. The torque control devices is the power tools. The power tools can be electric wrench, electric screwdriver, electric drill, and so on.

In one embodiment, a computer-readable medium recording instructions is disclosed. When the recorded computer instructions are executed by a processor of an torque control device, the torque control device can perform the method.

In one embodiment, a torque control scheme is disclosed. The effectiveness of the torque can be verified according to the first torque value Tset set by the user, the second torque value Ti obtained by the some parameters, and the third torque value Ts uploaded by the one or more torque sensors, the control operations of the motor can be performed according to the effectiveness of the torque. The multiple torque values are compared to determine whether the multiple torque values are normal, the multiple torque values are obtained by a variety of ways, the accuracy of the torque and the control effect of the motor can be improved. The torque control scheme is simple and has a low processing capacity of the equipment, the verification of the torque can be determined without increasing the processing capacity of the equipment, the cost of the verification of the torque is reduced, and the user's experience is improved.

When functions implemented by a form of software functional units are sold or used in product, the functions can be stored in the computer-readable medium. Based on understanding, technical solution of the present disclosure can be displayed in form of software products, part of the technical solution of the present disclosure that contributes to the prior art in essence can also be displayed in the form of the software products. The software products is stored in a storage medium. The software produces include multiple instructions to make a computer device perform the method in all embodiments. The computer-readable medium can be an internal storage system, such as a flash memory, a random access memory (RAM) for temporary storage of information, and/or a read-only memory (ROM) for permanent storage of information.

The embodiments shown and described above are only examples. Many details known in the field are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general mannering of the terms used in the claims. It will therefore be appreciated that the embodiments described above may be modified within the scope of the claims.

1. A torque control method comprising:
receiving a first torque value Tset of a torque of a motor of presetting;
obtaining a second torque value Ti of the torque of the motor according to gathering parameters, wherein the gathering parameters are operating parameters of the motor;
obtaining a third torque value Ts of the torque of the motor uploaded by one or more torque sensors;
verifying an effectiveness of the torque according to the first torque value Tset, the second torque value Ti, and the third torque value Ts; and
controlling operating states of the motor according to the effectiveness of the torque.

2. The torque control method of claim 1, wherein verifying the effectiveness of the torque according to the first torque value Tset, the second torque value Ti, and the third torque value Ts comprises:
calculating a first difference value T1 between the first torque value Tset and the second torque value Ti;
calculating a second difference value T2 between the second torque value Ti and the third torque value Ts;
calculating a third difference value T3 between the first torque value Tset and the third torque value Ts; and
verifying the effectiveness of the torque according to the first difference value T1, the second difference value T2, and the third difference value T3;
wherein verifying the effectiveness of the torque according to the first difference value T1, the second difference value T2, and the third difference value T3 comprises:
outputting an effective result of the torque, when at least one of the first difference value T1, the second difference value T2, and the third difference value T3 meets a validity condition.

3. The torque control method of claim 1, wherein verifying the effectiveness of the torque according to the first torque value Tset, the second torque value Ti, and the third torque value Ts comprises:
obtaining corresponding relationships among the second torque value Ti, the third torque value Ts, and torque difference value T;
determining the effectiveness of the torque according to the first torque value Tset, the second torque value Ti, the third torque value Ts, and the corresponding relationships.

4. The torque control method of claim 3, wherein determining the effectiveness of the torque according to the first torque value Tset, the second torque value Ti, the third torque value Ts, and the corresponding relationships comprises:
calculating a first difference value T1 between the first torque value Tset and the second torque value Ti;
calculating a third difference value T3 between the first torque value Tset and the third torque value Ts;
calculating a second difference value T2 between the second torque value Ti and the third torque value Ts, when at least one of the first difference value T1, and the third difference value T3 meets a validity condition;
obtaining the torque difference value T according to the second torque value Ti and/or the third torque value Ts, and the corresponding relationships; and
outputting an effective result of the torque, when a different value between the second difference value T2 and the torque difference value T is less than a specified threshold.

5. The torque control method of claim 3, wherein determining the effectiveness of the torque according to the first torque value Tset, the second torque value Ti, the third torque value Ts, and the corresponding relationships comprises:
calculating a first difference value T1 between the first torque value Tset and the second torque value Ti;
calculating a second difference value T2 between the second torque value Ti and the third torque value Ts;
calculating a third difference value T3 between the first torque value Tset and the third torque value Ts;
obtaining the torque difference value T according to the corresponding relationships;
outputting an effective result of the torque, when a difference value between the torque difference value T and at least one of the first difference value T1, the second difference value T2, and the third difference value T3 is less than a specified threshold.

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. A torque control device comprising:
a sampling circuit, a processing circuit, one or more torque sensors and a control unit, wherein the sampling circuit gathers gathering parameters, the processing circuit obtains a second torque value Ti of a torque of a motor according to the gathering parameters, the gathering parameters are operating parameters of the motor, the one or more torque sensors obtain a third torque value Ts of the torque of the motor, the control unit obtains the second torque value Ti, and the third torque value Ts, the control unit verifies an effectiveness of the torque according to the second torque value Ti, and the third torque value Ts, and outputs control information of the motor according to the effectiveness of the torque.

18. (canceled)

19. A torque control device comprising:
at least one processor; and
a data storage storing one or more programs which when executed by the at least one processor, cause the at least one processor to:
obtain a second torque value Ti of a torque of a motor according to gathering parameters, wherein the gathering parameters are operating parameters of the motor;
obtain a third torque value Ts of the torque of the motor uploaded by one or more torque sensors;
verify an effectiveness of the torque according to the second torque value Ti, and the third torque value Ts; and
control operating states of the motor according to the effectiveness of the torque.

20. (canceled)

21. The torque control device of claim 17, wherein the control unit verifies the effectiveness of the torque according to the second torque value Ti and the third torque value Ts comprises:
obtaining corresponding relationships among the second torque value Ti, the third torque value Ts, and a torque difference value T;
determining the effectiveness of the torque according to the second torque value Ti, the third torque value Ts, and the corresponding relationships.

22. The torque control device of claim 21, wherein determining the effectiveness of the torque according to the second torque value Ti, the third torque value Ts, and the corresponding relationships comprises:
calculating a second difference value T2 between the second torque value Ti and the third torque value Ts;
obtaining the torque difference value T between the second torque value Ti and the corresponding relationships, or obtaining the torque difference value T between the third torque value Ts and the corresponding relationships, or obtaining the torque difference value T between the second torque value Ti, the third torque value Ts and the corresponding relationships; and
outputting an effective result of the torque, when a different value between the second difference value T2 and the torque difference value T is less than a specified threshold.

23. The torque control device of claim 17, wherein the torque control device further comprises a human-computer interaction module, the human-computer interaction module receives a first torque value Tset of the torque of the motor of presetting;
the control unit obtains the first torque value Tset, verifies the effectiveness of the torque according to the first torque value Tset, the second torque value Ti, and the third torque value Ts, and outputs control information of the motor according to the effectiveness of the torque.

24. The torque control device of claim 23, wherein the control unit verifies the effectiveness of the torque according to the first torque value Tset, the second torque value Ti, and the third torque value Ts comprises:
calculating a first difference value T1 between the first torque value Tset and the second torque value Ti;
calculating a second difference value T2 between the second torque value Ti and the third torque value Ts;
calculating a third difference value T3 between the first torque value Tset and the third torque value Ts; and
verifying the effectiveness of the torque according to the first difference value T1, the second difference value T2, and the third difference value T3;
wherein the control unit verifying the effectiveness of the torque according to the first difference value T1, the second difference value T2, and the third difference value T3 comprises:
outputting an effective result of the torque, when at least one of the first difference value T1, the second difference value T2, and the third difference value T3 meets a validity condition.

25. The torque control device of claim 23, wherein the control unit verifying the effectiveness of the torque according to the first torque value Tset, the second torque value Ti, and the third torque value Ts comprises:
obtaining corresponding relationships among the second torque value Ti, the third torque value Ts, and torque difference value T;
determining the effectiveness of the torque according to the first torque value Tset, the second torque value Ti, the third torque value Ts, and the corresponding relationships.

26. The torque control device of claim 25, wherein the control unit determining the effectiveness of the torque according to the first torque value Tset, the second torque value Ti, the third torque value Ts, and the corresponding relationships comprises:
calculating a first difference value T1 between the first torque value Tset and the second torque value Ti;
calculating a third difference value T3 between the first torque value Tset and the third torque value Ts;
calculating a second difference value T2 between the second torque value Ti and the third torque value Ts, when at least one of the first difference value T1, and the third difference value T3 meets a validity condition;
obtaining the torque difference value T according to the second torque value Ti and/or the third torque value Ts, and the corresponding relationships; and
outputting an effective result of the torque, when a different value between the second difference value T2 and the torque difference value T is less than a specified threshold.

27. The torque control device of claim 25, wherein the control unit determining the effectiveness of the torque according to the first torque value Tset, the second torque value Ti, the third torque value Ts, and the corresponding relationships comprises:
calculating a first difference value T1 between the first torque value Tset and the second torque value Ti;
calculating a second difference value T2 between the second torque value Ti and the third torque value Ts;
calculating a third difference value T3 between the first torque value Tset and the third torque value Ts;
obtaining the torque difference value T according to the corresponding relationships;
outputting an effective result of the torque, when a difference value between the torque difference value T and at least one of the first difference value T1, the second difference value T2, and the third difference value T3 is less than a specified threshold.

28. The torque control device of claim 19, wherein the at least one processor verifying the effectiveness of the torque according to the second torque value Ti and the third torque value Ts comprises:
obtaining corresponding relationships among the second torque value Ti, the third torque value Ts, and a torque difference value T;
determining the effectiveness of the torque according to the second torque value Ti, the third torque value Ts, and the corresponding relationships.

29. The torque control device of claim 28, wherein the at least one processor determining the effectiveness of the torque according to the second torque value Ti, the third torque value Ts, and the corresponding relationships comprises:
calculating a second difference value T2 between the second torque value Ti and the third torque value Ts;
obtaining the torque difference value T between the second torque value Ti and the corresponding relationships, or obtaining the torque difference value T between the third torque value Ts and the corresponding relationships, or obtaining the torque difference value T between the second torque value Ti, the third torque value Ts and the corresponding relationships; and
outputting an effective result of the torque, when a different value between the second difference value T2 and the torque difference value T is less than a specified threshold.

30. The torque control device of claim 19, wherein the at least one processor further causes to receive a first torque value Tset of the torque of the motor of presetting, obtain the first torque value Tset, verify the effectiveness of the torque according to the first torque value Tset, the second torque value Ti, and the third torque value Ts, and outputs control information of the motor according to the effectiveness of the torque.

31. The torque control device of claim 30, wherein the at least one processor verifying the effectiveness of the torque according to the first torque value Tset, the second torque value Ti, and the third torque value Ts comprises:
calculating a first difference value T1 between the first torque value Tset and the second torque value Ti;
calculating a second difference value T2 between the second torque value Ti and the third torque value Ts;
calculating a third difference value T3 between the first torque value Tset and the third torque value Ts; and
verifying the effectiveness of the torque according to the first difference value T1, the second difference value T2, and the third difference value T3;
wherein the at least one processor verifying the effectiveness of the torque according to the first difference value T1, the second difference value T2, and the third difference value T3 comprises:
outputting an effective result of the torque, when at least one of the first difference value T1, the second difference value T2, and the third difference value T3 meets a validity condition.

32. The torque control device of claim 30, wherein the at least one processor verifying the effectiveness of the torque according to the first torque value Tset, the second torque value Ti, and the third torque value Ts comprises:
obtaining corresponding relationships among the second torque value Ti, the third torque value Ts, and torque difference value T;
determining the effectiveness of the torque according to the first torque value Tset, the second torque value Ti, the third torque value Ts, and the corresponding relationships.

33. The torque control device of claim 32, wherein the at least one processor determining the effectiveness of the torque according to the first torque value Tset, the second torque value Ti, the third torque value Ts, and the corresponding relationships comprises:
calculating a first difference value T1 between the first torque value Tset and the second torque value Ti;
calculating a third difference value T3 between the first torque value Tset and the third torque value Ts;
calculating a second difference value T2 between the second torque value Ti and the third torque value Ts, when at least one of the first difference value T1, and the third difference value T3 meets a validity condition;
obtaining the torque difference value T according to the second torque value Ti and/or the third torque value Ts, and the corresponding relationships; and
outputting an effective result of the torque, when a different value between the second difference value T2 and the torque difference value T is less than a specified threshold.
